(19) United States
(12) Patent Application Publication
(10) Pub. No.: US 2008/0111814 A1
(43) Pub. Date: May 15, 2008

(54) Geometric tagging

(75) Inventors: Srinivasan H. Sengamedu, Bangalore (IN); Subhajit Sanyal, Bangalore (IN)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/600,347

(22) Filed: Nov. 15, 2006

(51) Int. Cl. G06T 15/00

(52) U.S. Cl. 345/419

(57) ABSTRACT

Geometric tagging is described. A method for transforming an image into a three dimensional (3D) representation includes receiving a first user input that specifies selection of a category from a set of categories of geometric objects. Each category of the set is associated with one or more taggable features. A list of user controls is presented that correspond to the taggable features of the category. A second user input is received via the list of user controls that associates tags within an image feature of an image. Each of the tags is associated with one of the taggable features. The image is processed according to the tags of the second user input. A 3D representation of the image is presented based on the processing. The image can include structured scenes, with planar and/or non-planar surfaces, and/or free-form surfaces.

The present invention relates generally to three dimensional reconstruction of images. More specifically, embodiments of the present invention relate to geometric tagging of images by users to facilitate the task of three dimensional reconstruction thereof.

### BACKGROUND

Multimedia content is a large and growing component of Internet traffic, including searches. Much of this multimedia content includes images. Major search portals such as Yahoo™ and Google™ provide prominent image related features with powerful image search capabilities. Images are often rendered in arrays of pixels.

Images rendered as pixel arrays are essentially two dimensional (2D) projections. Images in 2D may lack one or more elements of information that are present in the real scene, which the image graphically represents. Such information gaps can be bridged to enhance user experience. However, user attention is needed for processing media informational content. Information gaps may be geometrically based.

Scenes that are based in reality provide visual information that relates to the three dimensions of length, breadth and depth. As real three dimensional (3D) scenes are represented as images, a geometric gap arises. The geometric gap results from the informational deficiencies inherent in representing real 3D scenes within the constraints of 2D images that can be displayed with a computer monitor, a television screen, or for that matter, a photograph, drawing or the like. Various techniques are currently used for rendering 3D scenes as 2D images.

Thus, raw 2D images may be thought of as suffering from a geometric deficiency. Images are essentially 2D pixel arrays and nontrivial processing is required to extract object and scene information therefrom. Computer vision research has addressed issues relating to the geometric gap. Object detection research addresses identification of objects in the image and scene reconstruction techniques address uncovering (or recovering) depth information from 2D images.

Significantly, fast, recent growth has occurred in the availability and use of digital cameras. This growth is significantly bolstered by the deployment of digital camera functionality with even more common and/or widely used devices such as cellular telephones (cellphones) and personal digital assistants (PDAs). The rise in digital camera use, coupled with the general ease with which digital images may be electronically stored and shared, transmitted in emails and posted in websites and the like, has led to a virtual explosion in the size and availability of digital image collections.

Notwithstanding their ready availability however, the usefulness of images for some applications, such as 3D modeling, “walkthroughs” of scenes and the adaptation of 2D images for other applications such as gaming and simulation remains rather low. Automatic techniques have been developed for 3D modeling of images. However, these techniques are typically computationally expensive and require levels of expertise that general users of image collections may consider inordinate.

Moreover, in the context of social computing and social networking based on computer networks, image search and image tagging with geometric information remains a significant challenge. The computational intensiveness and bandwidth consumption associated with the techniques, as well as the expertise demanded of users, contributes to these issues. Thus, conventional computer vision tools remain expensive to access and complicated to use, which may tend to limit 2D-3D image conversion, related applications, and searches of large image collections based on geometric image information to professional or other high end use, and unfortunately, perhaps out of reach to most users in the social computing context.

Thus, the geometric gap in images remains a significant issue. It would be useful to close the geometric gap and to leverage the sizable and useful array of techniques developed by the computer vision community to do so. Further, it would be useful to close the geometric gap with one or more techniques that provide utility at the internet scale and/or in the context of social computing and without undue reliance on perhaps somewhat limited user computing resources, e.g., at a client. Moreover, geometric and related scene information, recovered from tagged images, could be useful in allowing more efficient generation of novel views, which could concomitantly increase the performance of other image detection and/or recognition processes and image search.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts example constraints on a face, according to an embodiment of the present invention;

FIGS. 2A and 2B depict an example reconstruction of a face, according to an embodiment of the present invention;

FIG. 3A and FIG. 3B depict adjacent faces, according to an embodiment of the invention;

FIG. 4 depicts an example of reconstructing a surface of revolution (SOR), according to an embodiment of the present invention;

FIG. 5 depicts a web based interface for geometric tagging of structured scenes, according to an embodiment of the invention;

FIG. 6A and FIG. 6B depict alternate views of an image, according to an embodiment of the invention;

FIG. 7 depicts a mesh model of a canonical face, according to an embodiment of the invention;

FIG. 8 depicts an example of an image of a human face, with which an embodiment of the present invention will be described;

FIG. 9 depicts an example tagging interface, according to an embodiment of the present invention;

FIG. 10 depicts points of a scaled mesh, centered and projected onto an uploaded working image, according to an embodiment of the present invention;

FIG. 11 depicts a portion of the display of the interactive tagging interface, according to an embodiment of the invention;

FIG. 12 depicts a profile view of a textured face model, reconstructed in 3D with a tagging process, according to an embodiment of the present invention;

FIG. 13 depicts a flowchart for an example process for deforming a 3D mesh mask model to fit it to an uploaded image, according to an embodiment of the present invention;

FIG. 14 depicts a flowchart for an example process for transforming an image into a 3D representation, according to an embodiment of the present invention;

FIG. 15 depicts a flowchart for an example process for transforming an image, depicting a free form surface, into a 3D representation, according to an embodiment of the present invention; and

FIG. 16 depicts an example computer system platform, with which one or more features, functions or aspects of one or more embodiments of the invention may be practiced.

### DETAILED DESCRIPTION

Geometric tagging is described herein. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### OVERVIEW

Embodiments are described herein, which relate to geometric tagging. In one embodiment, a method for transforming an image into a three dimensional (3D) representation includes receiving a first user input that specifies selection of a category from a set of categories of geometric objects. Each category of the set is associated with one or more taggable features. A list of user controls is presented that correspond to the taggable features of the category. A second user input is received via the list of user controls that associates tags within an image feature of an image.

It is to be understood that the two user inputs described comprise an example embodiment. Embodiments of the present invention are not limited to two user inputs. In another example embodiment, fewer than two user inputs are received. In one embodiment for example, an image type associated with an image, such as “structured” or “free form” is detected automatically, thus obviating one user input corresponding thereto. Moreover, while example embodiments are described with reference to structured scenes and free form surfaces, it should be understood that these descriptions are by way of illustration and are not meant to be construed as in any way limiting. Embodiments of the present invention are well suited to use tags in a variety of other ways.

In one embodiment, each of the tags is associated with one of the taggable features. The image is processed according to the tags of the second user input. A 3D representation of the image is presented based on the processing. The image can include structured scenes, with planar and/or non-planar surfaces, and/or free-form surfaces. In one embodiment, the three dimensional representation of the reality based scene is accessibly storable in a social computing context with the electronic source, the storage unit and/or a storage repository.

Embodiments of the present invention thus address the geometric gap in images. In one embodiment, computer vision techniques are leveraged to allow users to tag images for 3D reconstruction thereof. Embodiments allow enhanced user experience relating to immersive viewing, interactive displays, 3D avatars and other features. Utility is provided at the internet scale and/or in the context of social computing. Thus, community efforts in building 3D models and social media and the like are enabled. Geometric and related scene information, recovered from tagged images, allows more efficient generation of novel views, 3D representation of 2D images and increases the performance of other image detection and/or recognition processes and image search.

### 3D Reconstruction

One embodiment implements geometric tagging using one or more three dimensional computer vision techniques. Cameras project three dimensional (3D) scenes based in reality on to a two dimensional (2D) display medium. Legacy cameras, for example use photosensitive silver emulsions, films and similar chemically based media to capture 2D information representative of 3D reality. Digital cameras essentially capture similar information but do so with photosensitive electronic devices such as charged coupled devices (CCDS) and store the captured information electronically within field effect transistors (FETs) of a flash memory or similar medium.

A camera's operation is modeled with perspective projection. Where the real world and camera coordinates are expressed in homogenous form, the camera operation is modeled as a matrix. The matrix depends on the focal length of the camera ‘f’, the pixel aspect ratio ‘s’, and the coordinates ‘c’ of the intersection of the optical axis and the retinal plane. A calibration matrix of the camera, sometimes referred to as an intrinsic camera matrix ‘K,’ can be described as

$$[ \begin{matrix}{f}_{x} & s & {c}_{x} \\ & {f}_{y} & {c}_{y} \\ & & 1\end{matrix} ] . \qquad ( Equation 1 )$$

### Denoting camera rotation with ‘R’ and the translation matrix with ‘t’, which is defined with respect to a chosen reference coordinate system (e.g., ‘x’ and ‘y’), the camera projection matrix, ‘P’ is given by

P=K[R^{T}|t] (Equation 2).

### In the simplified pinhole projection model, the camera projection matrix P relates a 3D point ‘X’ and its corresponding image point ‘x’ as

x˜PX (Equation 3),

where x and X are represented in terms of their homogeneous coordinates and the equation is defined up to a scale. The camera internal matrix K (EQ. 1) can be computed from the vanishing points of three orthogonal directions.

In a typical application scenario, multiple images may be available. Where this is so, the relation between the two images can be expressed using epipolar relations. Where x and x′ are two corresponding points,

x^{fT}Fx=0 (Equation 4).

where F is the fundamental matrix. The fundamental matrix F is a 3×3 matrix and can be computed with a process characterized with a linear algorithm, if eight pairs of corresponding points are known. In one implementation, seven pairs suffice to compute the matrix F with a process characterized with a non-linear algorithm, which exploits the ranking of F as 2.

If x is a point in the image plane, then the expression

K⁻¹x

is a ray. Constraints, such as presence on a particular plane or the like, are used, with the availability of K or F, for automatic 3D reconstruction. The reconstruction is performed at various levels, such as projective, affine, metric, and Euclidean. For visualization, various implementations use metric or Euclidean reconstruction. Various types of constraints are used to achieve this and include, in some implementations, scene constraints, camera motion constraints and constraints imposed on intrinsic camera properties.

One implementation uses a 3D mesh model for an object, in which 3D reconstruction is achieved with techniques that include registration and analysis by synthesis. In this implementation, an initial coarse registration between the mesh model and the image is obtained. The model thus registered is then projected, e.g., using P, to 2D. The coarse registration is refined to minimize error.

To recover geometry of free form surfaces from their images, one implementation uses information in the image in one or more of several ways. Such information includes shading, texture and focus. Shading information, such as shading characteristics of an object under illumination in a 2D image, provides a visual cue for recovery of its 3D shape. Texture information includes image plane variations in texture related properties such as density, size and orientation and provide clues about the 3D shape of the objects in 2D images.

Focus information is available from the optical system of an imaging device. Optical systems have a finite depth of field. Objects in a 2D image which are within the finite depth of field appear focused within the image. In contrast, objects that were at depths outside the depth of field appear in the image (if at all) to be blurred to a degree that matches their distance from the finite depth of field. This feature is exploited in shape from focus techniques for 3D reconstruction in one implementation.

Video streams are rich sources of information for recovering 3D structure from 2D images. A process of one implementation applies one or more motion related algorithms that use factorization.

### Geometric Tagging

Human vision recovers 3D information stereoscopically and stereo images and/or videos, where available, are readily exploitable for recovering 3D information. While in video and stereo applications, the quality of recovered information may not be optimal. However, humans use knowledge of objects in recovering depth information. Geometric tagging is used to provide this high-level information and to improve the quality of reconstruction. Tagging systems may confront inherent unreliability in information. In one implementation, tagging is used in the context of gaming to increase the reliability of tags.

Embodiments of the present invention also use additional information for 3D reconstruction. This information includes vanishing points, correspondence and/or surface constraints, which can be estimated with image processing techniques. Human beings are generally skillful at providing such information. In one embodiment, this human skillfulness is leveraged. Users provide the information with tags that are added with inputs made with one or more interfaces, an interactive display, and/or a graphical user interface (GUI).

While semantic tagging of images is a relatively simple operation and demands no special skills or expertise, tagging the geometry in images, in any sort of meaningful, systematic and/or sophisticated fashion, is significantly more complex. It can depend on an underlying framework for analysis and representation of the geometric information. In one embodiment, the framework for geometric tagging uses natural and/or intuitive user specified constraints.

Real world objects can be broadly classified as either more or less structured or as free form. Typically, the geometry of structured objects is readily described in terms of simple primitive shapes, such as planes, cylinders, spheres and the like. For structured scenes therefore, one embodiment uses a natural and intuitive approach that includes identifying and tagging different geometric primitives that appear in images of those scenes. In contrast, for tagging free form objects, one embodiment uses a model based registration approach, which allows the tagging made therewith to retain simplicity and remain intuitive. Certain classes of commonly occurring objects are pre-identified and a database of canonical models is kept for each class. Users identify the class of the object and then register the imaged geometry with the canonical model representative of that class.

In one implementation that adopts a model based approach, effectiveness in some circumstances may relate to the size of the database and the variety of information stored therewith. In this implementation moreover, in some situations the recovered geometry information may include a “best fit” approximation of, in contrast to an exact duplication of the inherent geometry of the real scene upon which an image is based. However, the model-based approach of this implementation simplifies the computerized processes involved. For instance, one or more algorithms upon which the computer implemented processes are based retain simplicity and are readily deployable on a web scale or its effective equivalent for deployment over a large network, internetwork or the like.

### Geometric Tagging of Structured Scenes

Typical non-curved man made structures comprise piecewise planar surfaces. Each planar surface is referred to as a face. Faces are consider to be general polygons. A scene is assumed to comprise a set of connected faces. In one implementation, the tagging process simultaneously reconstructs the set of connected faces using a least squares computation. The method of 3D reconstruction in one implementation adopts one or more principles that are described in Sturm, P. and Maybank, S., “A Method for Interactive 3D Reconstruction of Piecewise Planar Objects from Single Images,” British Machine Vision Conference, pp. 265-274, Nottingham, England, UK (September 1999), which is incorporated by reference for all purposes as if fully set forth herein.

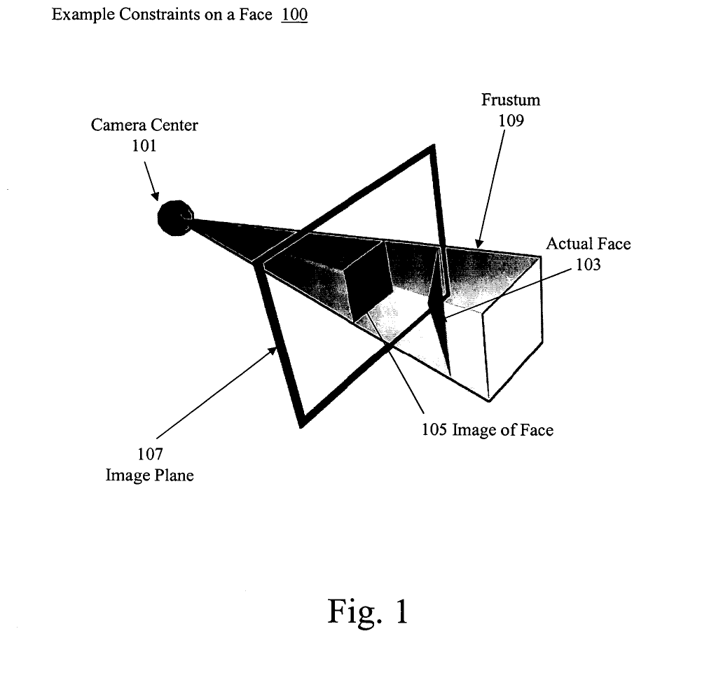

To reconstruct a polygonal face from an image, the image edges corresponding to the edges of the face are identified. FIG. 1 depicts example constraints 100 on a face, according to an embodiment of the present invention. The edges of the face in its image 105 are identified, which constrains the actual face 103 in the “real world” scene to lie within a frustum 109 that originates from the camera center 101. Frustum 109 essentially defines the extents of the image face 105 and the actual face 103, within the frustum 109, can be at any arbitrary orientation. Frustum 109 can be thought of, in one sense, as a part of a solid between two parallel planes cutting the solid, such as a section of a pyramid (or a cone or another like solid) between the base thereof and a plane parallel to the base.

To fix the orientation of the face 103 in the image thereof 105, the vanishing line of the plane of the face 103 is identified in image plane 107. In one implementation, for a rectangular face or for a face in the shape of a parallelogram, this is readily computed from the image edges of the face 103 within image plane 107. Identifying the vanishing points of at least two directions on the image plane 107 (or on a plane parallel thereto) of the face suffices to determine the vanishing line of the image plane 107.

However, fixing the direction does not completely resolve ambiguity in the reconstruction. The face can be any one of the essentially infinite number of possible faces that are generated by the intersections of a family of parallel planes (in the specified direction) with the frustum 109. In one embodiment, this ambiguity is resolved with specifying one or more additional constraints on its position with respect to a previously reconstructed face.

A linear system is implemented for simultaneously reconstructing a set of connected faces according to this embodiment. Without losing generality, a face is considered to be a quadrilateral. In another implementation, the faces are considered to be polygonal faces of arbitrary degree. In the present embodiment, a face is represented as a list of four vertices ‘v’ considered in some cyclic order, such described in Equations 5, below.

{v₁=(v₁^{x},v₁^{y},v₁^{z})^{T}, v₂=(v₂^{x}, v₂^{y},v₂^{z})^{T}, v₃=(v₃^{x},v₃^{y},v₃^{z})^{T}, v₄=(v₄^{x},v₄^{y},v₄^{z})^{T}} (Equations 5).

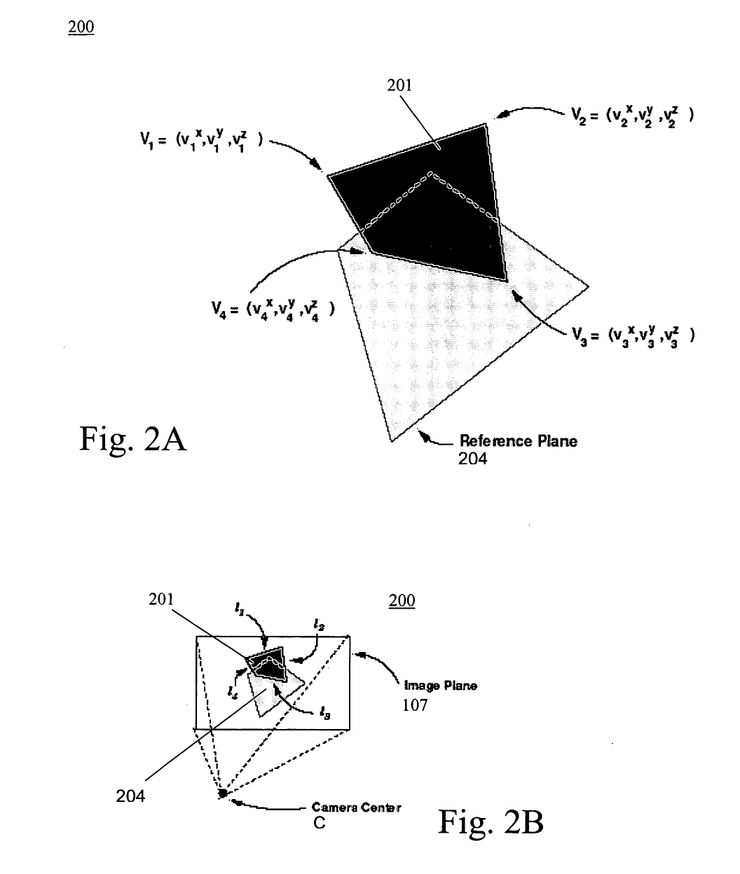

To reconstruct a face in this representation, twelve coordinates are determined. FIGS. 2A and 2B depict an example reconstruction 200 of a single face, according to an embodiment of the present invention. The Euclidean calibration ‘P’ of the camera, whose center C is shown in FIG. 2B is determined according to Equation 6, below.

$$\begin{matrix}P = K [ I \text{\textbar} t ] \\ = ( \tilde{P} , {p}_{4} ) .\end{matrix} \qquad ( Equation 6 )$$

In Equation 6, p₄ refers to the fourth column, \tilde{P} represents the first 3×3 part of the projection matrix P, I refers to the 3×3 identity matrix and t represents the camera translation with respect to a chosen world coordinate system. The world coordinate system is assumed to be located at the camera center, which implies that

t=[0,0,0]^{T}. (Equation 7).

Modern image management applications allow computers to process “information content” associated with photographs and other images. The information content associated with a digital image may include metadata about the image, as well as data that describes the pixels of which the image is formed. The metadata can include, for example, text and keywords for an image's caption, version enumeration, file names, file sizes, image sizes (e.g., as normally rendered upon display), resolution and opacity at various sizes and other information.

Image keywords, Exchangeable Image File (EXIF) and International Press Telecommunications Council (IPTC) may also be associated with an image and incorporated into its metadata. EXIF metadata is typically embedded into an image file with the digital camera that captured the particular image. These EXIF metadata relate to image capture and similar information that can pertain to the visual appearance of an image when it is presented. EXIF metadata typically relate to camera settings that were in effect when the picture was taken (e.g., when the image was captured). Such camera settings include, for example, shutter speed, aperture, focal length, exposure, light metering pattern (e.g., center, side, etc.) flash setting information (e.g., duration, brightness, directedness, etc.), and the date and time that the camera recorded the photograph. Embedded IPTC data can include a caption for the image and a place and date that the photograph was taken, as well as copyright information.

In one embodiment, the EXIF data in the image header is utilized to obtain the focal length information, from which the camera internal matrix K is set up for the 3D reconstruction. Skew parameters are ignored and it is assumed in one implementation that the principal point is to be situated at the center of the image. Where no pertinent EXIF data is available (e.g., with an image derived with scanning a legacy photograph), typical settings for the camera parameters can be selected by a user, applied as default settings or automatically set according to some other information that is inherent in the image and/or data or metadata associated therewith the image and 3D reconstruction proceeds on the basis thereof. Further, users may interactively modify the parameters and obtain visual feed-back from the reconstructed model.

The four edges of the face in the image are identified. Equations for the four lines corresponding to these edges are denoted as l₁, l₂, l₃ and l₄. Each edge lᵢ is back projected (projected backwards) to obtain the planes containing the different vertices of the face. These planes form the frustum 109 (FIG. 1). The constraints (e.g., on the vertices of the face) that are derived from these planes as the frustum constraints. For the more darkly shaded face 201 in FIG. 2A and FIG. 2B, there are twelve frustum constraints, which are of the form described in Equation 8, below.

(P^{T}lᵢ)[vⱼ^{x},vⱼ^{y},vⱼ^{z},1]^{T=}0 (Equation 8).

where the subscript i refers to the four face edges and the subscript j refers to the vertices that lie on that edge (e.g., i=1 and j=1, 2).

The vanishing line is determined for the more darkly shaded face 201 in the image and the equation of this line is denoted as lᵥ. The vanishing line for a plane is obtained in one implementation with determining the vanishing points of two different directions on this plane (or e.g., on a plane parallel thereto). In typical architectural scenes, the faces encountered tend to be more or less rectangular and the edges of a face can be utilized to determine two vanishing points, and thus the vanishing line for the plane of the face. The edges of structures, windows and/or doors for instance, are usable for determining the vanishing line for a face in an example architectural scene. The vanishing line lᵥ of the more darkly shaded face 201 is used to compute the normal to the face. The normal ‘n’ to a face with vanishing line lᵥ is obtained as

n=K^{T}lᵥ (Equation 9).

Determining the normal n to the face fixes the orientation of the face and thus constrains the vertices of the face. These constraints are referred to as the orientation constraints. The orientation constraints for the more darkly shaded face 201 are given with Equations 10, below.

$${( {K}^{T} {𝓁}_{v} )}^{T} ( {v}_{2} - {v}_{1} ) = 0 \\ {( {K}^{T} {𝓁}_{v} )}^{T} ( {v}_{3} - {v}_{2} ) = 0 \\ {( {K}^{T} {𝓁}_{v} )}^{T} ( {v}_{4} - {v}_{3} ) = 0 \\ {( {K}^{T} {𝓁}_{v} )}^{T} ( {v}_{1} - {v}_{4} ) = 0. \qquad ( Equation 10 )$$

### Only three of the four Equations 10 above are linearly independent; the first three are used in one embodiment to form the linear system.

A constraint is specified to fix the position of the face. In one implementation, the constraint is specified that some edge or one of the vertices of the face lies on another plane, the equation of which is known. This constraint is referred to as an incidence constraint. For the situation depicted in FIG. 2A and FIG. 2B, it is assumed that the equation of the reference plane 204 (shown with lighter shading) is given as Equation 11, below.

[Ñ^{T},d][, vₛ^{T},1]^{T}=0 (Equation 11).

### Using the twelve frustum constraints, three orientation constraints, and the incidence constraint one implementation sets up the linear system as shown in Equation 12, below.

$$( \begin{matrix}{𝓁}_{1}^{T} \tilde{P} & 0 & 0 & 0 & {𝓁}_{1}^{T} {p}_{4} \\ 0 & {𝓁}_{1}^{T} \tilde{P} & 0 & 0 & {𝓁}_{1}^{T} {p}_{4} \\ 0 & {𝓁}_{2}^{T} \tilde{P} & 0 & 0 & {𝓁}_{2}^{T} {p}_{4} \\ 0 & 0 & {𝓁}_{2}^{T} \tilde{P} & 0 & {𝓁}_{2}^{T} {p}_{4} \\ 0 & 0 & {𝓁}_{3}^{T} {p}_{4} & 0 & {𝓁}_{3}^{T} {p}_{4} \\ 0 & 0 & 0 & {𝓁}_{3}^{T} \tilde{P} & {𝓁}_{3}^{T} {p}_{4} \\ 0 & 0 & 0 & {𝓁}_{4}^{T} \tilde{P} & {𝓁}_{4}^{T} {p}_{4} \\ {𝓁}_{4}^{T} P & 0 & 0 & 0 & {𝓁}_{4}^{T} {p}_{4} \\ - {( {K}^{T} {𝓁}_{v} )}^{T} & {( {K}^{T} {𝓁}_{v} )}^{T} & 0 & 0 & 0 \\ 0 & - {( {K}^{T} {𝓁}_{v} )}^{T} & {( {K}^{T} {𝓁}_{v} )}^{T} & 0 & 0 \\ 0 & 0 & - {( {K}^{T} {𝓁}_{v} )}^{T} & {( {K}^{T} {𝓁}_{v} )}^{T} & 0 \\ 0 & 0 & {\tilde{N}}^{T} & 0 & - d\end{matrix} ) ( \begin{matrix}{v}_{1} \\ {v}_{2} \\ {v}_{3} \\ {v}_{4} \\ 1\end{matrix} ) = 0. \qquad ( Equation 12 )$$

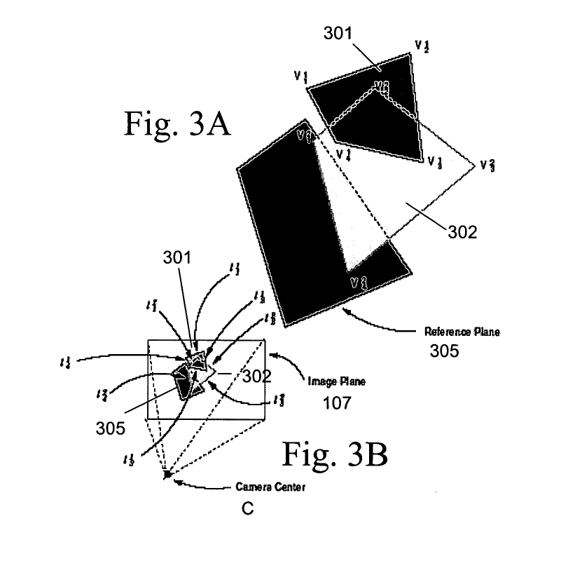

Equation 12 is of the form AX=0. The solution ‘X’ is obtained as the right null space of ‘A’ which is a 12×13 matrix. In one implementation, the solution obtained is corrected for the scale to make the last entry of the vector X as unity. In forming the linear system given in Equation 12, it is assumed that the equation of the reference plane [Ñ^{T}, d]^{T} is known. However, when solving for a system of connected faces simultaneously, the validity of this assumption may no longer hold. For a set of connected faces therefore in one implementation, the incidence constraint is used in a form to set up a common linear system, as seen with reference to FIG. 3.

FIG. 3A and FIG. 3B depict two adjacent faces 301 and 302. The un-shaded face 302 is adjacent to a reference face 305 (shown lightly shaded), the equation of which is known. The unknown vertices and the imaged edges of the un-shaded face 302 and the more darkly shaded face 301 are annotated as ‘v’. The vanishing line for the faces 301 and 302 are denoted lᵥ¹ and lᵥ², respectively. One embodiment sets up a linear system to solve for both the faces 301 and 302 simultaneously. For each of the two faces 301 and 302, frustum constraints and orientation constraints are applied as described above. For the face 301, the incidence constraint is expressed in Equation 13, below.

(RK^{T}lᵥ²)^{T}(vₛ¹−v₃²)=0 (Equation 13).

### The incidence constraint for the face 302, with respect to the reference face 305 is expressed in Equation 14, below.

[Ñ^{T},d][v₃^{2T},1]^{T}=0 (Equation 14).

In Equation 14, the term [Ñ^{T}, d] is the equation of the reference face 305. In one implementation, the frustum constraints and orientation constraints of the two faces are collected, with the incidence constraints of Equations 13 and 14, to set up a single linear system. The linear system so formed is solved to obtain the two faces 301 and 302 simultaneously. Multiple connected faces are handled in a similar fashion. In one embodiment, at least one reference face is used, the equation of which is known.

One implementation however allows an Euclidean reconstruction to be obtained, which is correct up to a scale. A scale is set up for the reconstruction by back projecting (e.g., projecting backwards) a point on the reference plane 305, which is assumed to be at some chosen distance from the camera. With the knowledge of the vanishing line for the plane, this allows the plane equation to be determined, essentially completely. One implementation allows tagging of non-planar (e.g., curved, etc.) objects in images of a more or less structured geometry.

The geometry of structured scenes is not limited to planar faces. Geometric primitives such as spheres, cylinders, quadric patches and the like are commonly found in many man made objects. Techniques from the computer vision fields allow the geometry of such structures to be analyzed and reconstructed. One embodiment handles the tagging of surfaces of revolutions (SOR).

A SOR is obtained by rotating a space curve around an axis, for instance, using techniques such as those described in Wong, K.-Y. K., Mendonca, P. R. S. and Cipolla, R., “Reconstruction of Surfaces of Revolution,” British Machine Vision Conference, Op. Cit. (2002) (hereinafter “Wong, et al.”), which is incorporated by reference for all purposes as if fully set forth herein. Surfaces such as spheres, cylinders, cones and the like are special cases of SORs.

To tag the geometry of a SOR, a silhouette edge of the SOR is indicated on the image. The indication of this silhouette, combined with information relating to the axis of revolution of the SOR, allows determination of the radii (e.g., of revolution) at different heights. Thus, the generating curve and hence the SOR can be readily computed.

In contrast to the techniques described in Wong, et al., one embodiment does not consider an SOR in isolation. The present embodiment considers an SOR, not in isolation, bust essentially resting on or otherwise proximate to one or more planar surfaces, which can be reconstructed using the techniques described above. Thus, the present embodiment determines an axis of the SOR for most common situations.

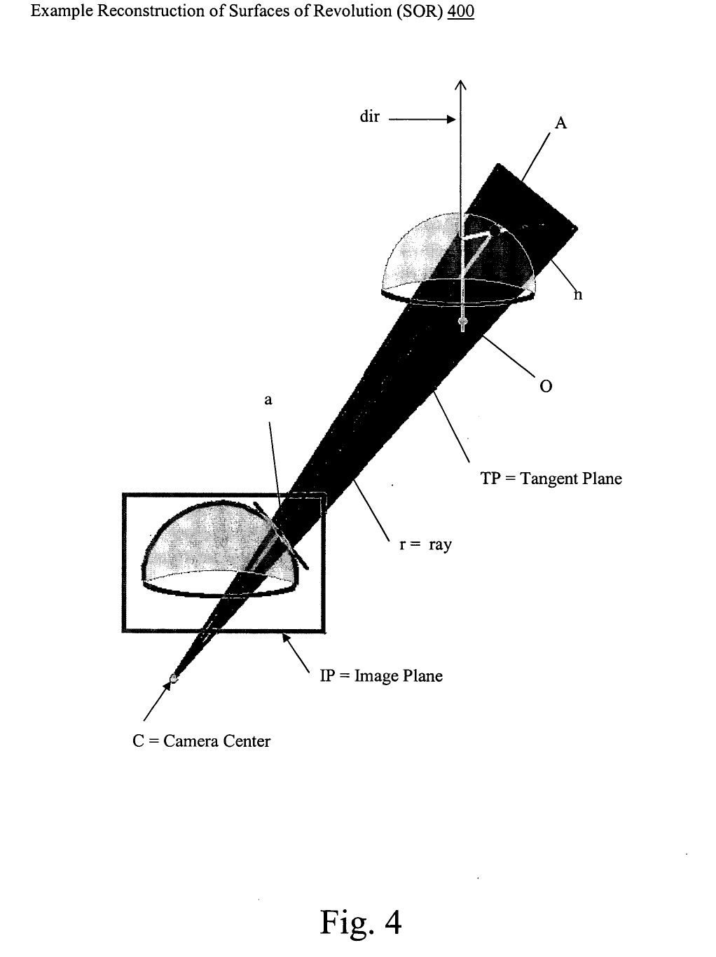

FIG. 4 depicts an example of reconstructing a SOR, according to an embodiment of the present invention. A parametric curve is fitted to the silhouette and sampled uniformly. In one implementation, the SOR is described with Equation 15, below.

C=O+λ₁dir+λ₂n+λ₃r (Equation 15).

In Equation 15, ‘n’ is the surface normal at a silhouette point and r is the direction vector from the silhouette point to the camera center ‘C’. The tangent line at a point, such as the point ‘a’ in FIG. 4, on the curve in the image gives us the equation of the plane tangent to the SOR at that point, such as point ‘A’ in FIG. 4.

Thus we determine ‘n’ given a point on the curve. The direction vector ‘r’ is determined by extending a ray from the camera center ‘C’ through the point on the silhouette. A unique solution exists for the three variables λ₁, λ₂ and λ₃. Since the camera projection matrix is known, for a given point on the silhouette the corresponding point on the other silhouette at the same height is readily computed. The radius for the height is computed by enforcing the constraint that the corresponding points are at the same distance from the axis.

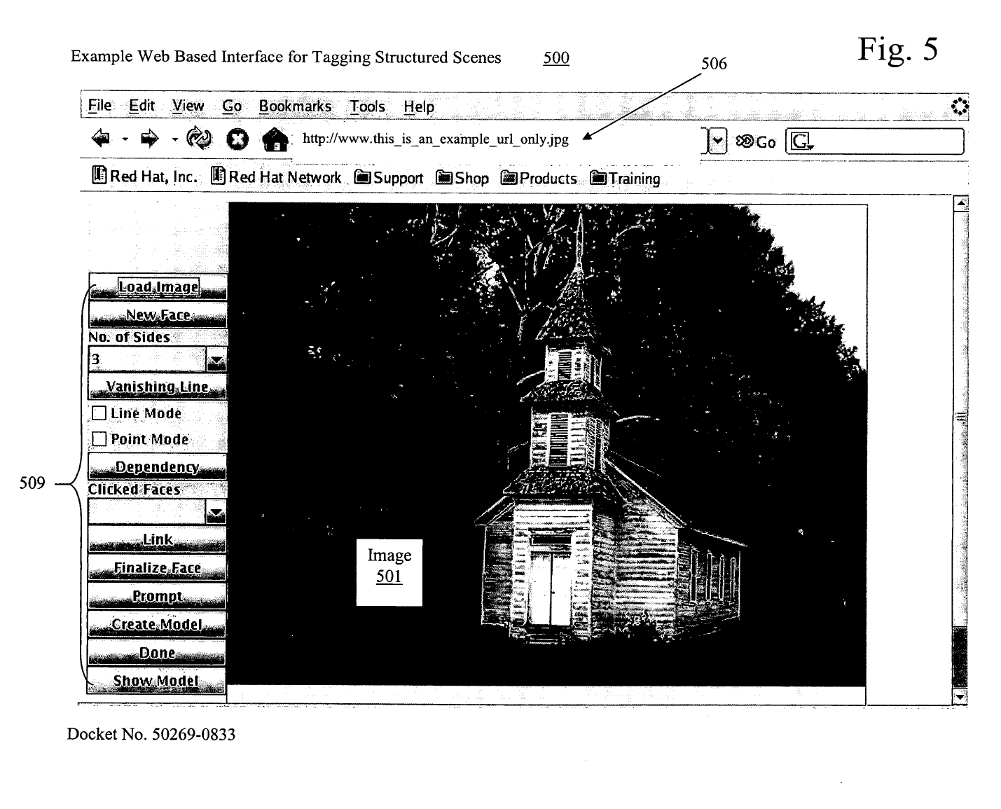

FIG. 5 depicts a web based interface 500 for geometric tagging of structured scenes, according to an embodiment of the present invention. In one implementation, web based interface 500 uses a co-operational GUI and web browser to interact via a network with a server of images and related information. In response to entering a uniform resource locator (URL) in interactive address field 506, an image 501 that corresponds to that URL is returned and displayed on the interactive monitor screen 504. Interactive tools 509 allow inputs for loading the image, accessing a new face thereof, designating a number of sides, a vanishing line mode, such as line or point mode, dependencies, selecting a face, creating or accessing links, prompts, finalizing face appearances, creating and showing models, and signaling that tagging is complete (e.g., ‘done’).

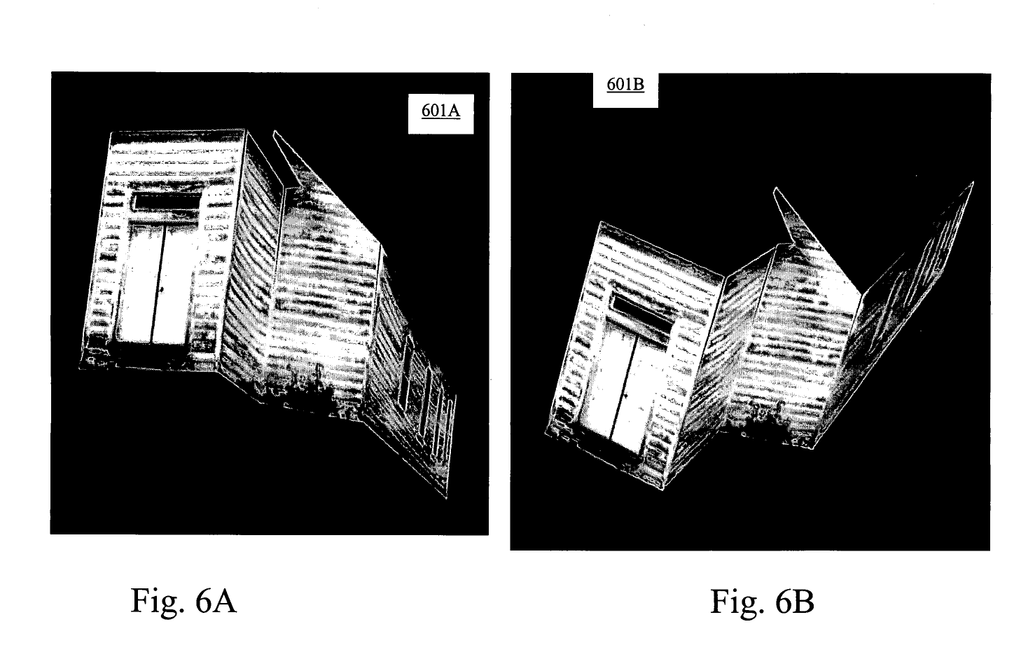

FIG. 6A and FIG. 6B each depict an alternate view of the image 501, based on the inputs made thereto with interface 500 (FIG. 5) to achieve partial tagging of geometric properties associated therewith. FIG. 6A shows a scene aspect 601A, in which image 501 (FIG. 5) is tagged to virtually “move around” image 501 and reconstruct it from a lower position angle and “to the image's left” with respect thereto. In contrast, FIG. 6B shows a scene aspect 601B, essentially complimentary to scene aspect 601B (FIG. 6A), in which image 501 (FIG. 5) is tagged to virtually “move around” image 501 and reconstruct it from a higher position angle and “to the image's left” with respect thereto.

### Geometric Tagging of Free Form Surfaces

Free form surfaces are those that are characterized by other than more or less structured scenes, other than linear, planar or other than planar more or less regular, symmetrical structures and/or a more or less conventional and/or invariant form. Attributes of free form surfaces may include one or more of a usually flowing shape, outline or the like that is asymmetrical in one or more aspects and/or a unique, variable, unusual and/or unconventional form. Human faces can be considered substantially free form surfaces and images thereof are substantially free form in appearance.

One embodiment allows tagging the geometry of free form surfaces using a registration based approach. In one embodiment, a database of 3D mesh models is maintained. The 3D mesh models are treated as canonical models (e.g., models based on canon, established standard, criterion, principle, character, type, kind or the like; models that conform to an orthodoxy, rules, types, kinds, etc.) for various object categories.

In one implementation, a user identifies an object in an image and selects an appropriate canonical model from the database. The user then identifies more or less simple geometric features or aspects of the object in the image and relates them with one or more inputs to corresponding features of the canonical model. Information that is based on this correspondence, e.g., correspondence information, is utilized to register the canonical model with the image.

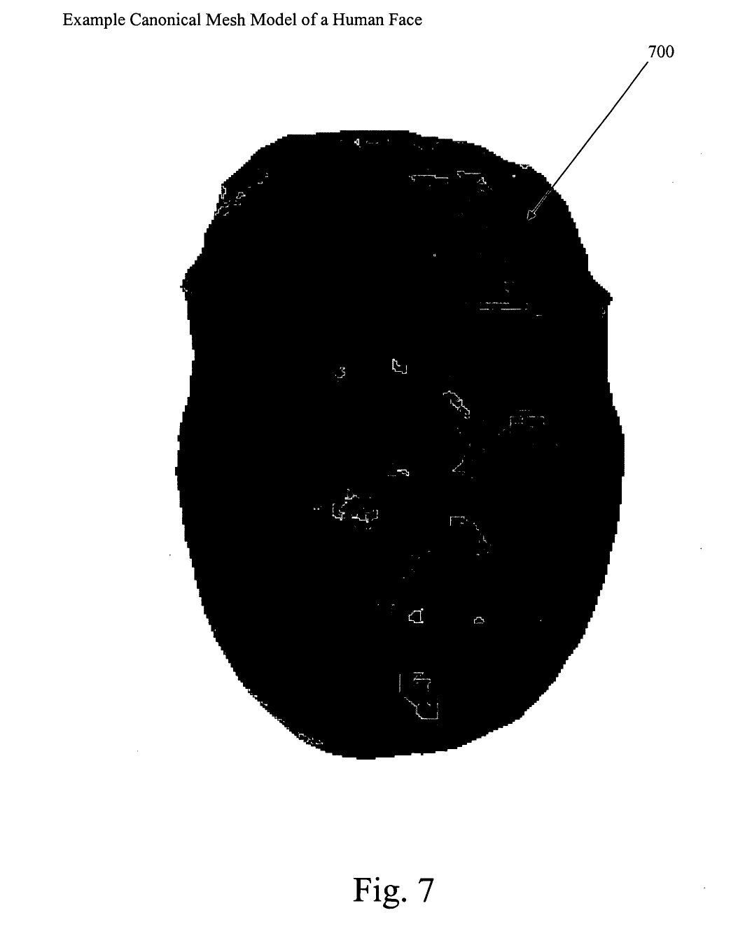

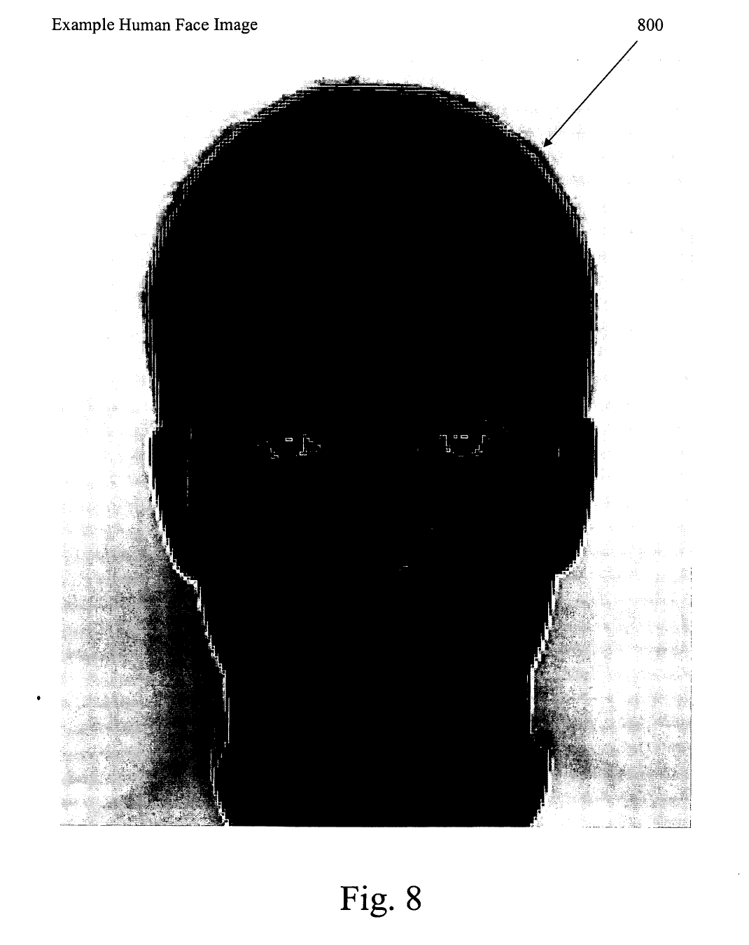

Human faces are an example of a free form surface. In one implementation, the geometry of human faces are tagged using images thereof, in which a mesh model is registered therewith. FIG. 7 depicts a mesh model 700 of a canonical face, according to an embodiment of the present invention. Any mesh model can be used; the mesh model depicted in FIG. 7 is available online from the public domain web site that corresponds to the URL <http://www.3dcafe.com>. FIG. 8 depicts an example of an image 800 of a human face, with which an embodiment of the present invention will be described. A user uploads the image 800 and uses an interactive tagging tool to register the canonical mesh model 700 (FIG. 7) associated with human faces with the image 800. In one embodiment, such registration uses one or more of EXIF data and other metadata, e.g., in a header associated with image 800, to obtain focal length information used to set up a camera matrix.

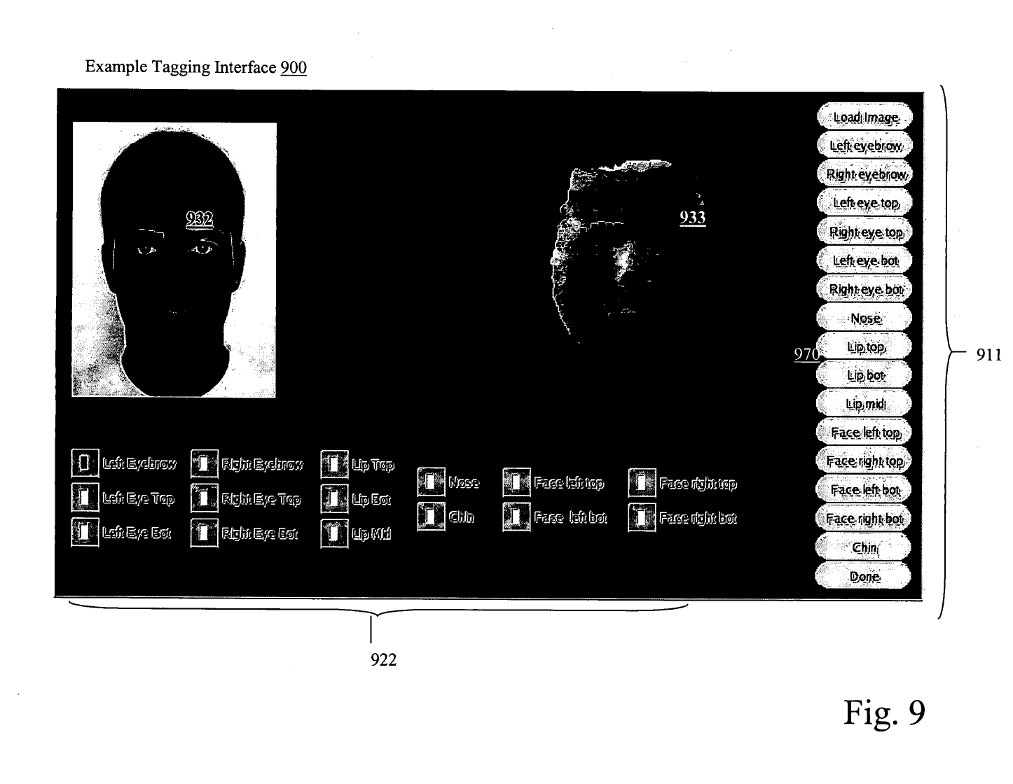

FIG. 9 depicts an example tagging interface 900, according to an embodiment of the present invention. In one implementation, tagging interfaces are available for any databased canonical 3D mesh model. As the user uploaded image 800 (FIG. 8), which corresponds to a human face, tagging interface 900 uploads the canonical 3D mesh model 700 (FIG. 7) that corresponds to human faces. In one embodiment, tagging interface 900 is implemented with a GUI and an interactive monitor screen, e.g., on a client, and a tagging interface processing unit on an image server networking with the client and/or the image database (e.g., in which the 3D canonical models are stored) through one or more networks, inter-networks, the Internet, etc.

The uploaded image 800 and mesh mask 700 are displayed together with tagging interface 900 as working image 980 and working mesh mask 970, respectively.

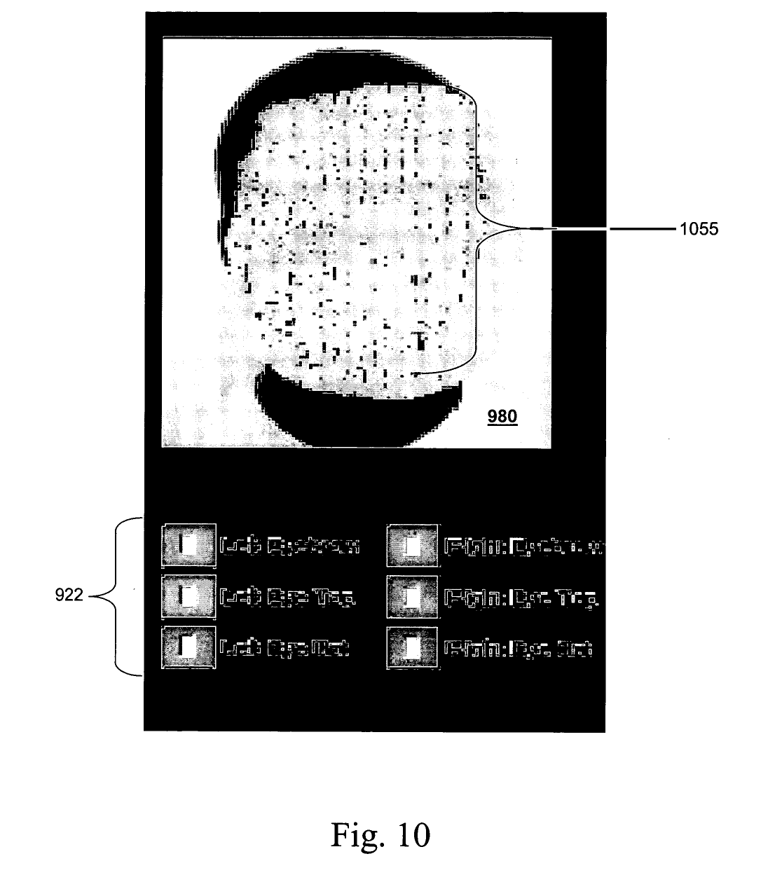

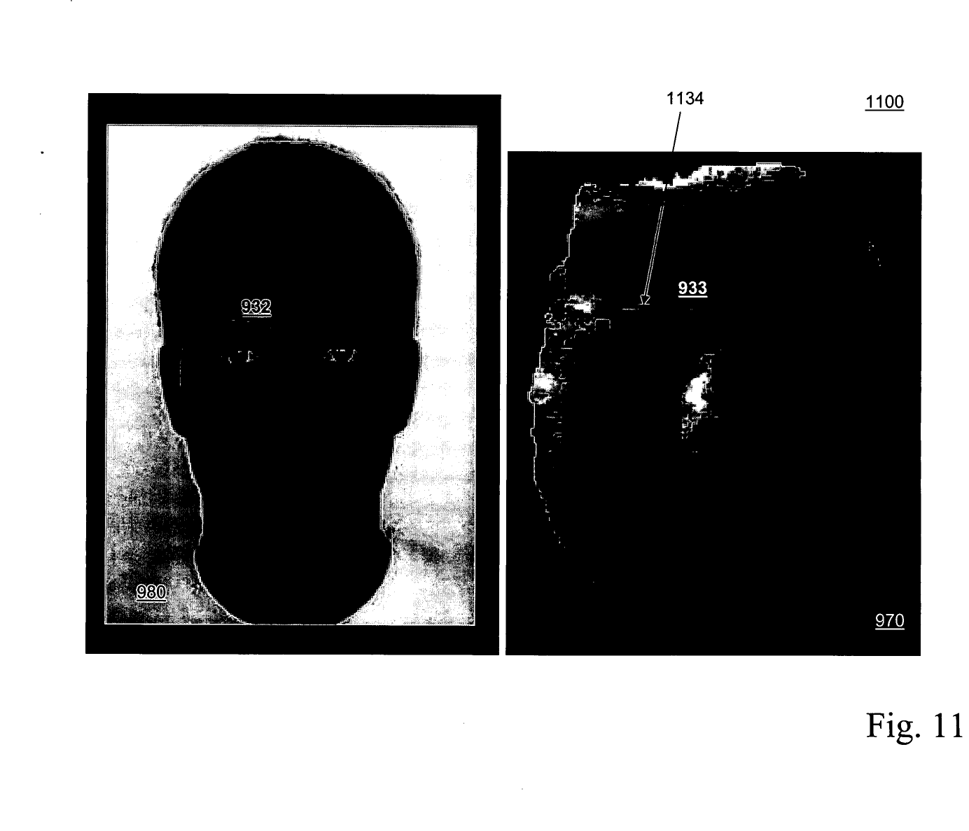

FIG. 10 depicts points 1055 of the scaled mesh, centered and projected onto the uploaded working image 980, according to an embodiment of the present invention. With reference to FIG. 9 and FIG. 10, users interactively adjust scaling parameters with feature selectors 922 and adjustment input buttons 911 to conform projected points 1055 so that they approximately fit inside the face area 1036 in the working image 980. The users tag various facial features, using feature selectors 922. In one embodiment, tagging interface 900 prompts the users in tagging a feature 932 with a showing of a corresponding feature “reflection” in the image 970 of the canonical mesh mask, as depicted in somewhat more detail with FIG. 11.

FIG. 11 depicts a portion 1100 of the display of the interactive tagging interface 900 (FIG. 9), according to an embodiment of the present invention. The guide points 932 indicated in the guide image 980, in the process of tagging, correspond to pre-indicated points 933 on the 3D canonical mesh 970. In one embodiment, a tagging process establishes a correspondence between the image 980 uploaded by a user and the canonical mesh model 970. This indirect scheme for establishing correspondence between mesh points 933 and corresponding points 932 in the uploaded image 980 effectively hides the complexity of manipulating the mesh for common users. The users thus have a simple, intuitive interface to tag the various geometric features in the image 980.

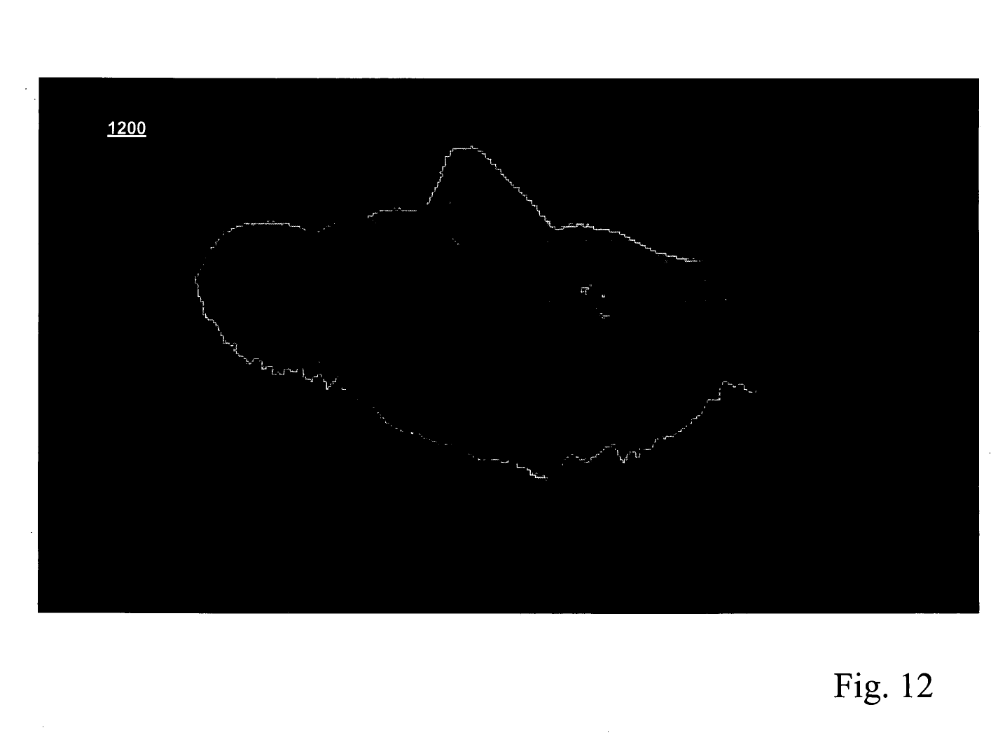

The correspondence between the mesh vertices 933 and the image points 932, established by such a tagging process, is utilized to deform the mesh mask model 970 and fit it to the imaged face 980. In one embodiment, a direct manipulation based free form mesh deformation framework is used to deform the mesh model 970 in response to the repositioning of the selected vertices 933. In one implementation, the deformation framework is described by Hsu, W., Hughes, J. and Kauffman, H., in “Direct manipulation of Free-Form Deformations,” SIGGRAPH, vol. 26 (1992), which is incorporated by reference for all purposes as if fully set forth herein. FIG. 12 depicts a profile view of a textured face model 1200, so reconstructed with such a tagging process, according to an embodiment of the present invention.

### EXAMPLE PROCESSES

### Process for Deforming a 3D Mesh Model to Fit an Uploaded Image

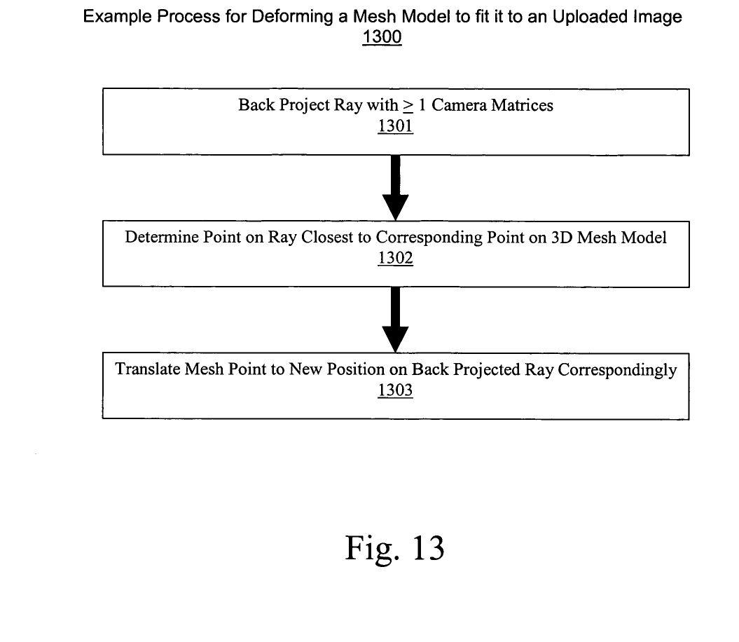

FIG. 13 depicts a flowchart for an example process 1300 for deforming a 3D mesh mask model (e.g., mesh model 700, 970; FIGS. 7, 9 & 10, respectively) to fit it to an uploaded image, according to an embodiment of the present invention. In block 1301, from an indicated feature point 932, a ray is back projected with one or more of the camera matrices described above. In block 1302, a point on the ray is determined which is closest to the corresponding point 933 on the 3D mesh model 970. In block 1303, the mesh point 933 is correspondingly translated to a new position on the back projected ray.

### Process for Transforming an Image into a 3D Representation

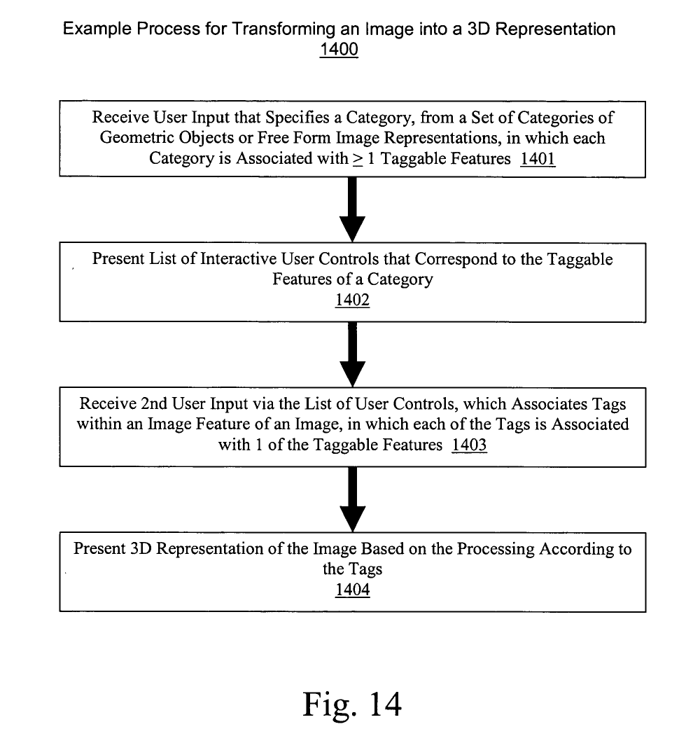

FIG. 14 depicts a flowchart for an example process 1400 for transforming an image into a 3D representation, according to an embodiment of the present invention. In block 1401, a user input is received that specifies a category, from a set of categories of geometric objects or free form image representations, in which each of the categories is associated with one or more taggable features. In block 1402, a list of interactive user controls is presented that correspond to the taggable features of the category.

In block 1403, a user input is received via the list of user controls, which associates tags within an image feature of an image. Each of the tags is associated with a taggable feature of the image. In block 1404, a 3D representation of the image is presented based on the tags.

### Transforming an Image Depicting Free Form Surfaces into a 3D Representation

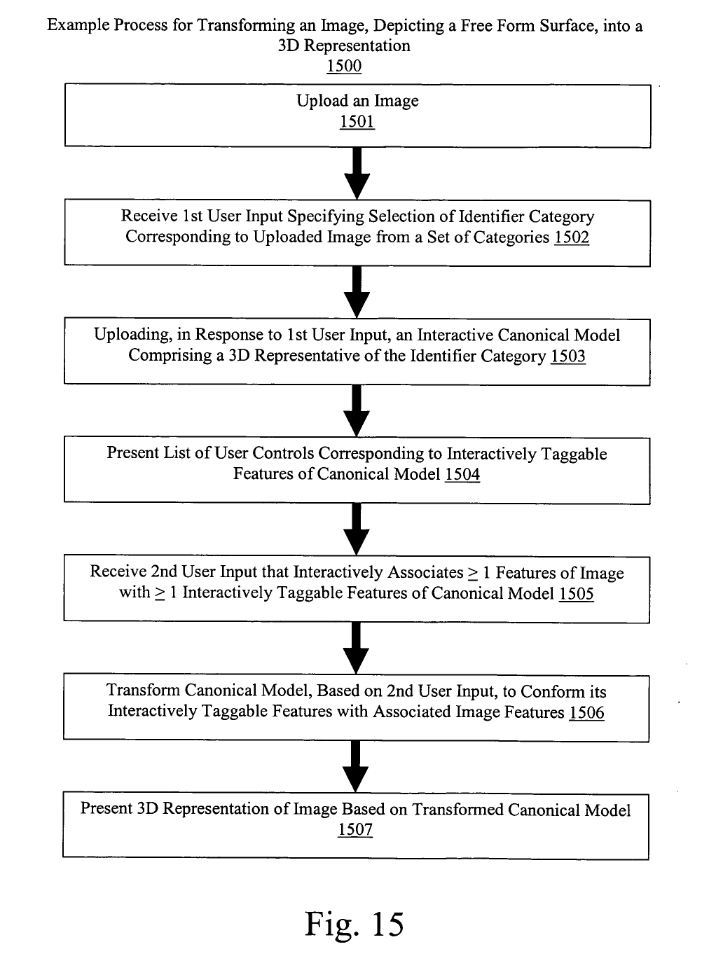

FIG. 15 depicts a flowchart for an example process 1500 for transforming an image into a 3D representation, according to an embodiment of the present invention. In block 1501, an image is uploaded. In block 1502, a first user input is received that specifies selection of an identifier category, which corresponds to the uploaded image, from a set of categories. For instance, one identifier category includes “human faces.” The identifier categories are essentially unlimited in nature, scope and number.

In block 1503, an interactive canonical model is uploaded or retrieved in response to the first user input. The interactive canonical model functions as a 3D representative of the identifier category. The 3D mesh model 700 (FIG. 7) is an example of an interactive canonical model representative of the identifier category “human faces.” In block 1504, a list of user controls is presented. The user controls correspond to interactively taggable features of the canonical model and allow the uploaded image to be tagged.

In block 1505, a second user input is received that interactively associates one or more features of the uploaded image with one or more interactively taggable features of the canonical model. In block 1506, the canonical model is transformed, based on the second user input, to conform its interactively taggable features to the associated features of the uploaded image. In block 1507, a 3D representation, such as textured face model 1200 (FIG. 12), is presented based on the transformed canonical model.

In various embodiments, these functions are performed with one or more computer implemented processes, with a GUI and image processing tools on a client or other computer, a computer based image server and/or another computer based system. In some embodiments, such processes are carried out, and such servers and other computer systems are implemented, with one or more processors executing machine readable program code that is stored encoded in a tangible computer readable medium or transmitted encoded on a signal, carrier wave or the like.

### Computer System Platform Example

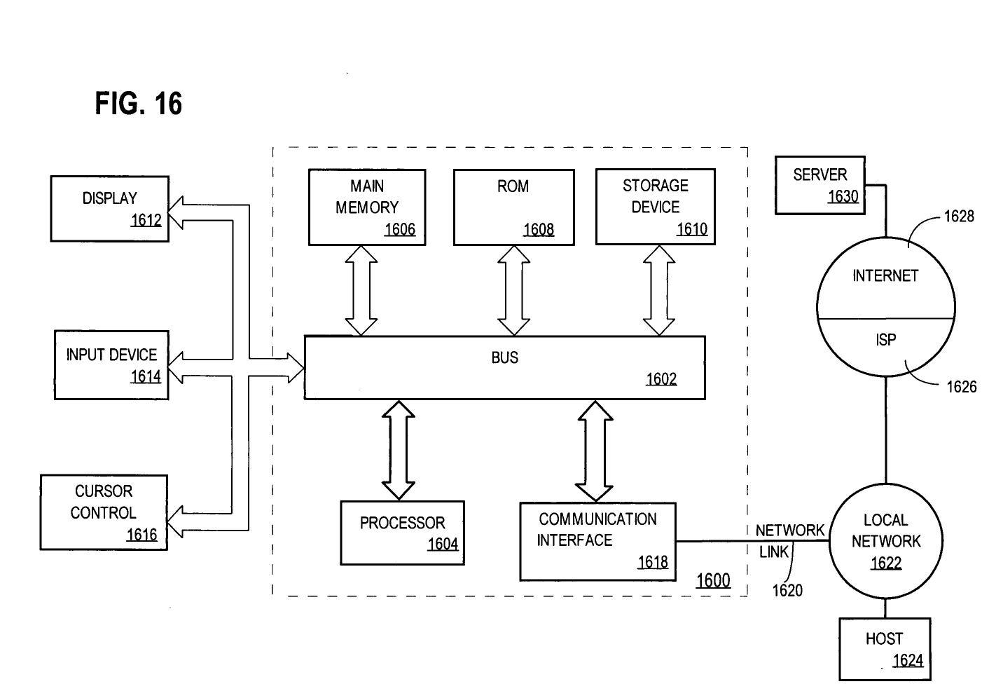

FIG. 16 depicts an example computer system platform 1600, with which one or more features, functions or aspects of one or more embodiments of the invention may be implemented. FIG. 16 is a block diagram that illustrates a computer system 1600 upon which an embodiment of the invention may be implemented. Computer system 1600 includes a bus 1602 or other communication mechanism for communicating information, and a processor 1604 coupled with bus 1602 for processing information.

Computer system 1600 also includes a main memory 1606, such as a random access memory (RAM) or other dynamic storage device, coupled to bus 1602 for storing information and instructions to be executed by processor 1604. Main memory 1606 also may be used for storing temporary variables or other intermediate information during execution of instructions to be executed by processor 1604. Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

Computer system 1600 may be coupled via bus 1602 to a display 1612, such as a cathode ray tube (CRT), liquid crystal display (LCD) or the like for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane.

The invention is related to the use of computer system 1600 for implementing the techniques described herein. According to one embodiment of the invention, those techniques are performed by computer system 1600 in response to processor 1604 executing one or more sequences of one or more instructions contained in main memory 1606. Such instructions may be read into main memory 1606 from another machine-readable medium, such as storage device 1610. Execution of the sequences of instructions contained in main memory 1606 causes processor 1604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1600, various machine-readable media are involved, for example, in providing instructions to processor 1604 for execution. Such a medium may take many forms, including but not limited to, non-volatile media, volatile media, and transmission media. Non-volatile media includes, for example, optical or magnetic disks, such as storage device 1610. Volatile media includes dynamic memory, such as main memory 1606. Transmission media includes coaxial cables, copper wire and fiber optics, including the wires that comprise bus 1602. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, legacy and other media such as punch cards, paper tape or another physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1604 for execution. For example, the instructions may initially be carried on a magnetic disk of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may optionally be stored on storage device 1610 either before or after execution by processor 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card, a cable or digital subscriber line (DSL) or other modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world wide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of carrier waves transporting the information.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618. The received code may be executed by processor 1604 as it is received, and/or stored in storage device 1610, or other non-volatile storage for later execution. In this manner, computer system 1600 may obtain application code in the form of a carrier wave.

### EXTENSIONS, ALTERNATIVES, EQUIVALENTS & MISCELLANEOUS

Geometric tagging is thus described. In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent amendment or correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for transforming an image into a three dimensional (3D) representation, comprising the steps of:
selecting a category from a set of categories of geometric objects based on at least one of a first user input and an automatic detection of the category, wherein each category of the set of categories is associated with one or more taggable features;
presenting a list of user controls that correspond to the taggable features of the category;
receiving a user input via the list of user controls, which associates tags within an image feature of an image, each of the tags providing geometric information about one of the taggable features and; and
presenting a 3D representation of the image based on the processing.

2. The method as recited in claim 1 wherein the categories of geometric objects comprise a category of objects associated with structured scenes.

3. The method as recited in claim 2 wherein the geometric objects associated with structured scenes comprise piece wise planar surfaces.

4. The method as recited in claim 3 wherein the planar surfaces comprise faces of general polygons.

5. The method as recited in claim 3 wherein the structured scene comprises a set of the faces, connected one to another.

6. The method as recited in claim 3 wherein the processing comprises reconstructing the set of connected faces with a least squares computation.

7. The method as recited in claim 2 wherein the geometric objects associated with structured scenes comprise one or more geometric primitives.

8. The method as recited in claim 7 wherein the geometric primitives comprise a surface having a curved aspect.

9. The method as recited in claim 7 wherein the geometric primitives comprise at least one of a sphere, a cylinder, a cone, and a quadric patch.

10. The method as recited in claim 7 wherein the image feature comprises at least one surface of revolution (SOR), wherein the second input comprises indicating on the image a silhouette edge of the SOR and wherein the processing comprises:
determining an axis of revolution associated with the image;
determining a plurality of radii of the SOR at different positions along the axis of revolution;
fitting a parametric generating curve to the silhouette with the axis of revolution and the plurality of radii;
determining a surface normal at a silhouette point and a direction vector therefrom to a camera center; and
enforcing a constraint wherein corresponding points of the silhouette are displayed equidistant from the axis of rotation.

11. The method as recited in claim 1 wherein the transforming an image is performed with one or more processors of a server.

12. A method for transforming an image, which depicts a free form surface, into a three dimensional (3D) representation thereof, comprising the steps of:
uploading the image that depicts the free form surface;
receiving a first user input that specifies selection of an identifier category corresponding to the uploaded image from a set of categories;
uploading, in response to the first input, an interactive canonical model that comprises a 3D representative of the identifier category;
presenting a list of user controls that correspond to interactively taggable features of the canonical model;
receiving a second user input via the list of user controls, which interactively associates one or more features of the image, with one or more of the taggable features of the canonical model;
transforming the canonical model, based on the second user input, to conform the one or more interactively taggable features thereof with the associated image features; and
presenting a 3D representation of the image based on the transformed canonical model.

13. The method as recited in claim 12 wherein the identifier category comprises an identifier associated with an object in the image wherein the object comprises the free form surface and wherein the first input comprises:
inputting the identifier; and
selecting an interactively conformational model that corresponds to the category from a stored plurality of canonical models that each correspond to at least one of the set of categories.

14. The method as recited in claim 13 wherein the presenting comprises:
in response to the first input, interactively displaying the image along with the selected interactively conformational model;
wherein the second user input via the list of user controls interactively applies one or more of the tags within the image feature of the image;
wherein the processing comprises conforming the conformational model based on the one or more tags; and
wherein the 3D representation comprises an instance of the conformational model that is conformed to the image with the processing based on the one or more tags.

15. The method as recited in claim 12 wherein the transforming an image is performed with one or more processors of a server.

16. A computer-readable medium carrying one or more sequences of instructions which, when executed by one or more processors, causes the one or more processors to perform the method recited in claim 1.

17. A computer-readable medium carrying one or more sequences of instructions which, when executed by one or more processors, causes the one or more processors to perform the method recited in claim 2.

18. A computer-readable medium carrying one or more sequences of instructions which, when executed by one or more processors, causes the one or more processors to perform the method recited in claim 3.

19. A computer-readable medium carrying one or more sequences of instructions which, when executed by one or more processors, causes the one or more processors to perform the method recited in claim 4.

20. A computer-readable medium carrying one or more sequences of instructions which, when executed by one or more processors, causes the one or more processors to perform the method recited in claim 5.

21. A computer-readable medium carrying one or more sequences of instructions which, when executed by one or more processors, causes the one or more processors to perform the method recited in claim 6.

22. A computer-readable medium carrying one or more sequences of instructions which, when executed by one or more processors, causes the one or more processors to perform the method recited in claim 7.

23. A computer-readable medium carrying one or more sequences of instructions which, when executed by one or more processors, causes the one or more processors to perform the method recited in claim 8.

24. A computer-readable medium carrying one or more sequences of instructions which, when executed by one or more processors, causes the one or more processors to perform the method recited in claim 9.

25. A computer-readable medium carrying one or more sequences of instructions which, when executed by one or more processors, causes the one or more processors to perform the method recited in claim 10.

26. A computer-readable medium carrying one or more sequences of instructions which, when executed by one or more processors, causes the one or more processors to perform the method recited in claim 11.

27. A computer-readable medium carrying one or more sequences of instructions which, when executed by one or more processors, causes the one or more processors to perform the method recited in claim 12.

28. A computer-readable medium carrying one or more sequences of instructions which, when executed by one or more processors, causes the one or more processors to perform the method recited in claim 13.

29. A computer-readable medium carrying one or more sequences of instructions which, when executed by one or more processors, causes the one or more processors to perform the method recited in claim 14.

30. A computer-readable medium carrying one or more sequences of instructions which, when executed by one or more processors, causes the one or more processors to perform the method recited in claim 15.
